(19) United States
(12) Patent Application Publication
(10) Pub. No.: US 2020/0318750 A1
(43) Pub. Date: Oct. 8, 2020

(54) ENHANCED DESIGN FOR PLUG VALVE

(71) Applicant: Halliburton Energy Services, Inc., Houston, TX (US)

(72) Inventors: Joe A. Beisel, Duncan, OK (US); James Olis, Duncan, OK (US)

(21) Appl. No.: 16/652,931

(22) PCT Filed: Dec. 19, 2017
(86) PCT No.: PCT/US2017/067308

§ 371 Date: Apr. 1, 2020

(51) Int. Cl. F16K 27/06; E21B 34/14

(52) U.S. Cl. CPC F16K 27/065; E21B 43/26; E21B 34/14

(57) ABSTRACT

Provided is a plug valve. The plug valve, in one example, includes a valve body having inlet and outlet seal inserts disposed within a central chamber thereof, a plug member disposed, in the central chamber, and a bonnet disposed at least partially within the central chamber and removably coupled to the valve body. The plug valve, in this example, further includes one or more substantially axial compression members positioned between the bonnet and the inlet and outlet seal inserts.

### BACKGROUND

Plug valves typically include a body having an inlet port, an outlet port and a central chamber extending between the inlet and outlet ports. A plug member is rotatably positioned inside the central chamber sandwiched between an upstream seal segment and a downstream seal segment. Each seal segment includes a through bore that is aligned with the respective inlet and outlet ports to form a flow passage through the plug valve body. The plug member also includes a central bore extending there through such that during operation, the plug member rotates between an open position, to align the central bore with the flow passage to facilitate fluid flow through the plug valve, and a closed position, to offset the central bore from the flow passage to block fluid flow through the plug valve.

Plug valves are designed so that the plug member shifts or otherwise “drifts' small amounts in the axial direction relative to the flow of fluid. This drift oftentimes enables fluid particulate to migrate between the plug member and the seal segments. For example, when the plug valve is in a closed position, the plug member drifts apart from the seal segment causing a gap to form between an inner surface of the inlet seal segment and an outer surface of the plug member. As a result, fluid and other fine particles such as, for example, frac sand, that flow through the plug valve will migrate between the seal segment and the plug member, which can accumulate, causing an increase in friction or imbed there between, which ultimately diminishes seal performance.

What is needed in the art is an improved design for a plug valve, a system using the same, and a method of use therefore that do not experience the problems of existing plug valve designs.

### BRIEF DESCRIPTION

Reference is now made to the following descriptions taken in conjunction with the accompanying drawings, in which:

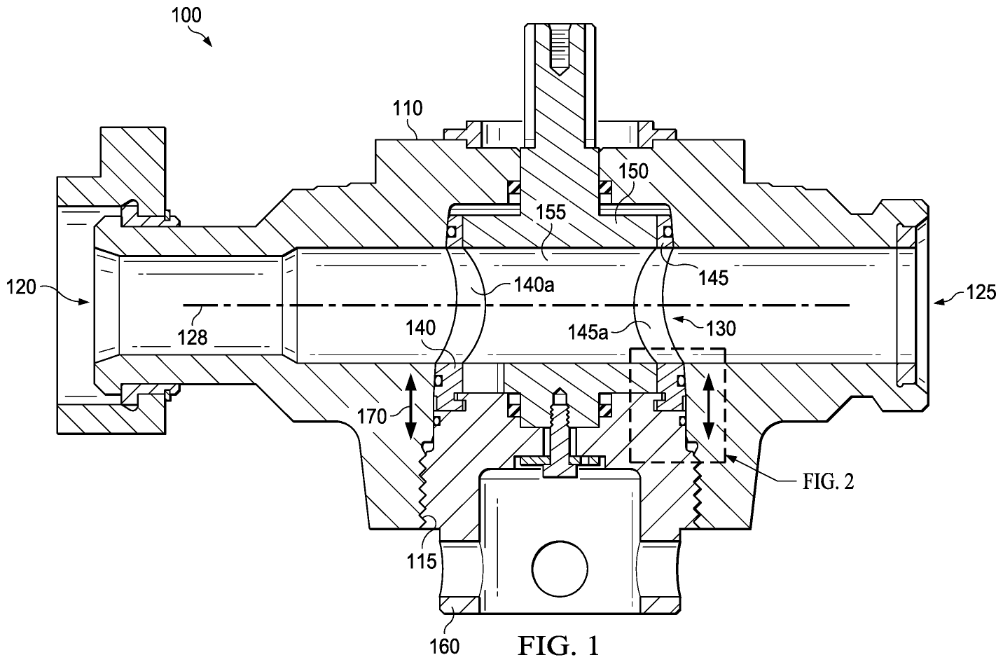

FIG. 1 illustrates a traditional plug valve as might be used in oil/gas operations;

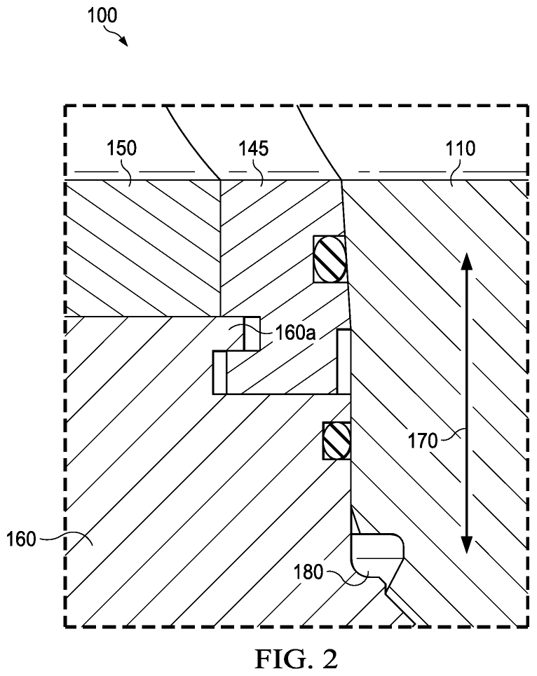

FIG. 2 illustrates a zoomed in view of an interaction between the valve body, the outlet seal insert and the bonnet of the traditional plug valve of FIG. 1;

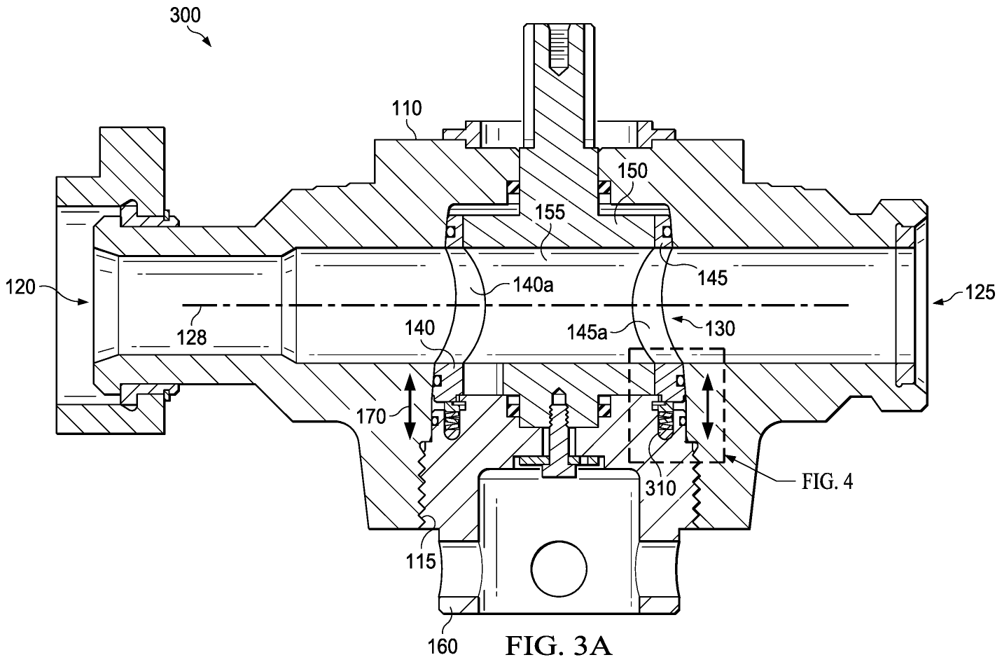

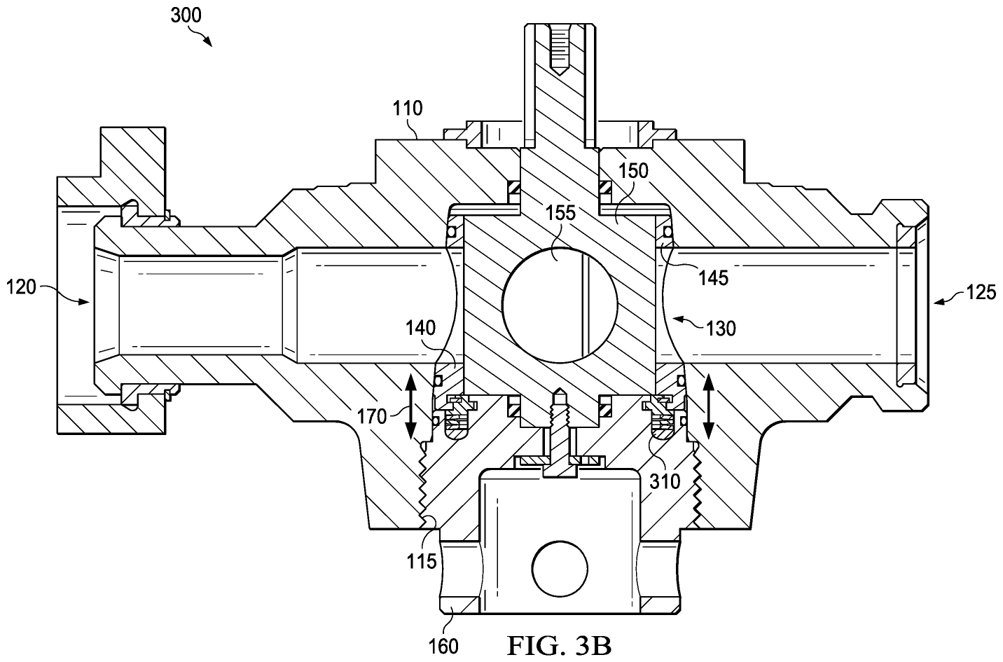

FIGS. 3A and 3B illustrates a plug valve manufactured in accordance with the disclosure;

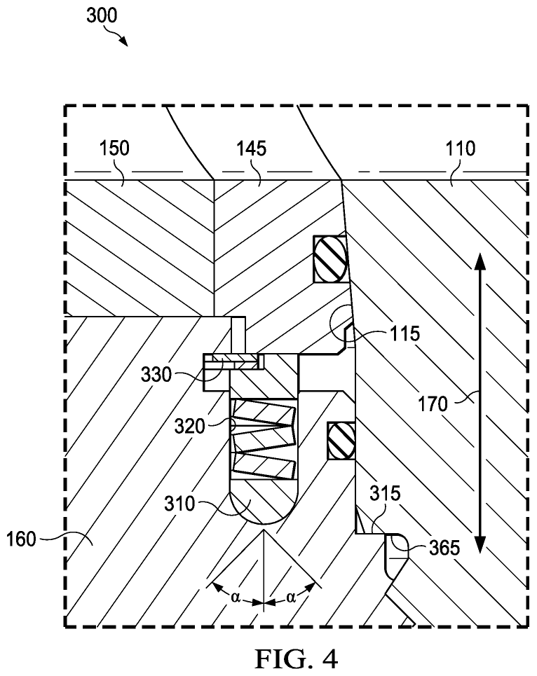

FIG. 4 illustrates a zoomed in view of an interaction between the valve body, the outlet seal insert, the bonnet and the substantially axial compression member of the plug valve of FIG. 3; and

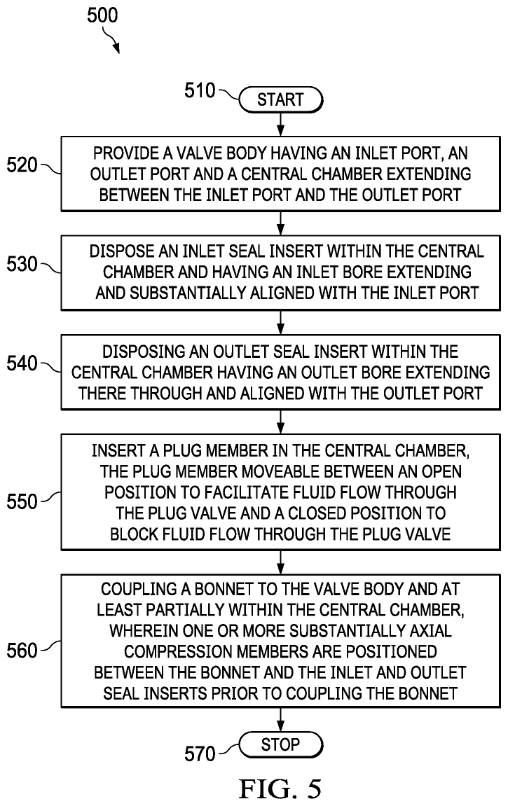

FIG. 5 illustrates a method of assembling a plug valve as provided in one embodiment of the disclosure; and

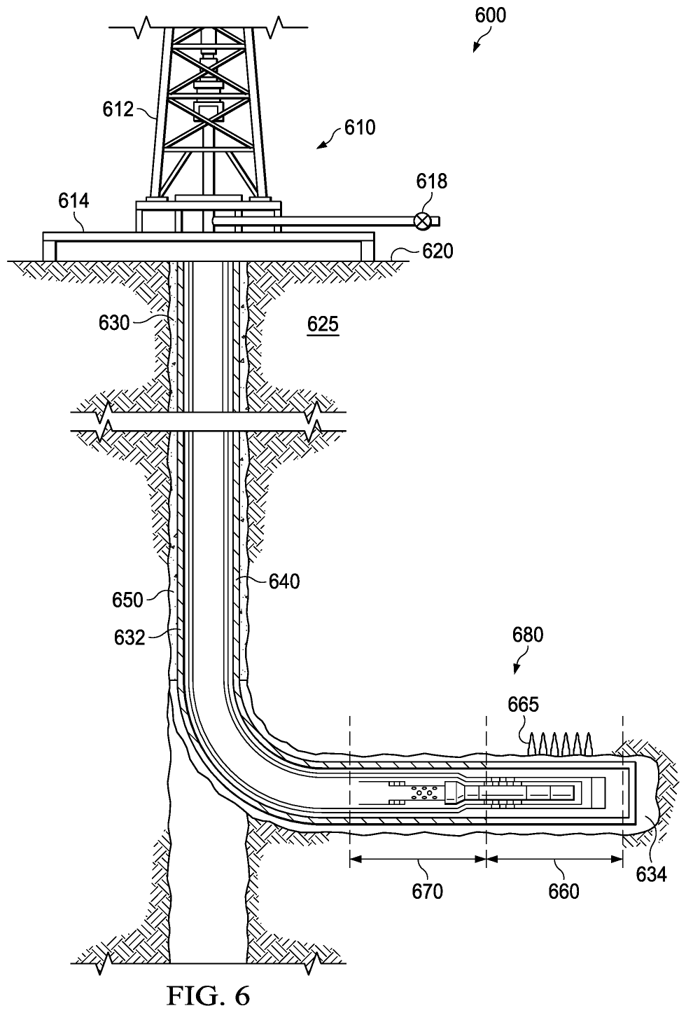

FIG. 6 illustrates a well system including an exemplary operating environment in accordance with the disclosure.

### DETAILED DESCRIPTION

In the drawings and descriptions that follow, like parts are typically marked throughout the specification and drawings with the same reference numerals, respectively. The drawn figures are not necessarily to scale. Certain features of the disclosure may be shown exaggerated in scale or in somewhat schematic form and some details of certain elements may not be shown in the interest of clarity and conciseness. The present disclosure may be implemented in embodiments of different forms. Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings of the embodiments discussed herein may be employed separately or in any suitable combination to produce desired results.

Unless otherwise specified, use of the terms “connect,” “engage,” “couple,” “attach,” or any other like term describing an interaction between elements is not meant to limit the interaction to direct interaction between the elements and may also include indirect interaction between the elements described.

Unless otherwise specified, use of the terms “up,” “upper,” “upward,” “uphole,” “upstream,” or other like terms shall be construed as generally toward the surface of the formation; likewise, use of the terms “down,” “lower,” “downward,” “downhole,” or other like terms shall be construed as generally toward the bottom, terminal end of a well, regardless of the wellbore orientation. Use of any one or more of the foregoing terms shall not be construed as denoting positions along a perfectly vertical axis. Unless otherwise specified, use of the term “subterranean formation” shall be construed as encompassing both areas below exposed earth and areas below earth covered by water such as ocean or fresh water.

Referring to FIG. 1, illustrated is a traditional plug valve 100 as might be used in oil/gas operations. The traditional plug valve 100 includes a valve body 110 with a central chamber 115 disposed between and connecting an inlet port 120 and an outlet port 125. The valve body 110, in the traditional plug valve 100 of FIG. 1, is a tapered valve body. The traditional plug valve 100 additionally includes a seal assembly 130. The seal assembly 130 includes an inlet seal insert 140 and an outlet seal insert 145. In the configuration of FIG. 1, the inlet seal insert 140 and outlet seal insert 145 are disposed within the central chamber 115, and each includes a bore 140a and 145a, respectively, extending there through and aligned with an axis 128 of the inlet and outlet ports 120 and 125.

As illustrated in FIG. 1, a plug member 150 is disposed within the central chamber 115 and is sandwiched between the inlet and outlet seal inserts 140 and 145. The plug member 150 includes a central bore 155 extending there through and is movable between an open position, such that the central bore 155 is aligned with the inlet and the outlet ports 120 and 125 to facilitate fluid flow through the plug valve 100, and a closed position, such that the central bore 155 is offset from and blocks the inlet and outlet ports 120 and 125 to prevent fluid flow through the plug valve 100. The plug valve 100 of FIG. 1 illustrates the plug member 150 in the open position.

The plug valve 100 of FIG. 1 further includes a bonnet 160. The bonnet 160, in accordance with the plug valve 100, is an adjusting nut that adjusts an amount of axial pressure 170 placed upon the inlet and outlet seal inserts 140 and 145. The axial pressure 170 pushes the inlet and outlet seal inserts 140 and 145 up into the valve body 110, thereby increasing a contact pressure between the inlet and outlet seal inserts 140 and 145 and the plug member 150. If the bonnet 160 provides too little axial pressure 170, the seal suffers, and if there is too much axial pressure 170, the inlet and outlet seal inserts 140 and 145 may warp, which again causes the seal to suffer. When the bonnet 160 is properly adjusted, the inlet and outlet seal inserts 140 and 145 may yield good sealing performance for many cycles.

Turning to FIG. 2, illustrated is a zoomed in view of an interaction between the valve body 110, the outlet seal insert 145 and the bonnet 160 of the traditional plug valve 100 of FIG. 1. As shown, adjusting the bonnet 160 moves the outlet seal insert 145 axially, thereby increasing or decreasing the axial pressure 170. Accordingly, an upper ledge of the bonnet 160 pushes upwards upon a lower edge of the outlet seal insert 145 when the axial pressure 170 is increased, and an ear 160a on the bonnet 160 pulls downward upon the outlet seal insert 145 when the axial pressure 170 is decreased. Additionally, clearance gap 180 may exist so that the pressure is applied to the outlet seal insert 145 rather than the valve body 110. In the embodiment of FIG. 2, the bonnet 160 does not directly contact the plug member 150, as shown by the spacer there between.

The present disclosure, is based at least in part, upon the acknowledgement that traditional plug valves, such as the plug valve 100 illustrated in FIG. 1, suffer from the difficulty, or inability, to quickly and precisely tailor the axial pressure for a given plug valve. The present disclosure has recognized, at least in part based upon this acknowledgment, that the difficulty in quickly and precisely tailoring the axial pressure for a given plug valve may be reduced or eliminated by including one or more compression members (e.g., spring members, crush sleeves or other similar members) between the bonnet and the inlet and outlet seal inserts. The compression members, in this embodiment, can be specifically tailored to provide precise axial pressure between the bonnet and the inlet and outlet seal inserts.

Turning to FIG. 3A, illustrated is a plug valve 300 manufactured in accordance with the disclosure. The plug valve 300 includes many of the same features as the traditional plug valve 100 illustrated in FIGS. 1 and 2. Accordingly, like reference numerals may be used to reference like features. The plug valve 300, in contrast to the plug valve 100, includes one or more substantially axial compression members 310. The phrase “substantially axial,” as it related to the substantially axial compression members, means that the substantially axial compression members 310 are directing the compression less than about 30 degrees (α) from parallel with the axis of rotation for the plug member 150. In an alternative embodiment, the plug valve 300 includes one or more strikingly axial compression members, wherein the strikingly axial compression members are directing the compression less than about 15 degrees (α) from parallel with the axis of rotation for the plug member 150, and in yet another embodiment the plug valve includes one or more ideally axial compression members, wherein the ideally axial compression members are directing the compression less than about 5 degrees (α) from parallel with the axis of rotation for the plug member 150.

The plug valve 300 illustrated in FIG. 3A, includes two substantially axial compression members 310 having a metal to metal seal (e.g., no non-metal seals) with the plug member 150. Accordingly, one substantially axial compression member 310 is coupled between the bonnet 160 and the inlet seal insert. 140, and thus configured to place axial compression upon the inlet seal insert 140. The other substantially axial compression member 310 is coupled between the bonnet 160 and the outlet seal insert 145, and thus configured to place axial compression upon the outlet seal insert 145.

Substantially axial compression members, such as the substantially axial compression members 310, may comprise a variety of different structures and remain within the purview of the disclosure. In the embodiment of FIG. 3A, the substantially axial compression members 310 are substantially axial spring members. For example, the substantially axial spring members could be substantially axial compression springs in one embodiment, and more specifically coil springs, machined springs, volute springs, wave springs, or gas/hydraulic springs, among other known designs. Of interest to the present disclosure, but not required in all embodiments, are substantially axial compression springs having a substantially constant spring force their deflection cycle. In other embodiments, the substantially axial compression members are not traditional springs, but are crush sleeves, belleville washers, bladder members, or other apparatuses capable of asserting axial compression on the inlet and outlet seal inserts.

Turning briefly to FIG. 3B, illustrated is the plug valve 300 of FIG. 3A, but wherein the plug member 150 is in the closed position. Accordingly, the central bore 155 is offset from and blocks the inlet and outlet ports 120 and 125 to prevent fluid flow through the plug valve 300, as compared to the illustration of FIG. 3A.

Turning to FIG. 4, illustrated is a zoomed in view of an interaction between the valve body 110 (e.g., a tapered valve body in one embodiment, or another wedge system in another embodiment), the outlet seal insert 145, the bonnet 160 and the substantially axial compression member 310 of the plug valve 300 of FIG. 3A. In the illustrated embodiment of FIG. 4, as the bonnet 160 is being removably coupled to the valve body 110 (e.g., the bonnet 160 is being screwed into the valve body 110 in one embodiment) corresponding surfaces of the valve body 110 and the bonnet 160, respectively, cause the bonnet 160 to limit out within the central chamber 115 as the bonnet 160 is removably coupled to the valve body 110. In the embodiment of FIG. 4, the valve 110 has a valve body no go shoulder 315 and the bonnet 160 has a corresponding bonnet no go shoulder 365. In this embodiment, the bonnet no go shoulder 365 is configured to limit out against the valve body no go shoulder 315 as the bonnet 160 is coupled (e.g. screwed) to the valve body 110.

The substantially axial compression member 310, in accordance with the embodiment of FIG. 4, is included within an opening 320 in the bonnet 160. The opening 320, in this embodiment, is specifically placed and sized to position the substantially axial compression member 310 such that it can provide axial compression directly (or indirectly) upon the inlet and outlet seal inserts (the outlet seal insert 145 illustrated in FIG. 4). The plug valve 300 illustrated in FIG. 4, further includes one or more compression member retaining devices 330, the one or more compression member retaining devices configured to maintain the substantially axial compression members 310 within the bonnet 160 during assembly of the plug valve 300.

Turning to FIG. 5, illustrates a method of assembling a plus valve 500, as provided in one embodiment of the disclosure. The method 500 begins in a start step 510. Thereafter, in a step 520 a valve body is provided having an inlet port, an outlet port and a central chamber extending between the inlet port and the outlet port. In a step 530, an inlet seal insert is disposed within the central chamber and having an inlet bore extending there through and substantially aligned with the inlet port. In a step 540, an outlet seal insert is disposed within the central chamber having an outlet bore extending there through and aligned with the outlet port. While steps 530 and 540 appear to be conducted in a specific order, those skilled in the art understand that the order of these steps may reversed, or alternatively they may be conducted at the same time.

Thereafter, in a step 550, a plug member is inserted in the central chamber, the plug member moveable between an open position to facilitate fluid flow through the plug valve and a closed position to block fluid flow through the plug valve. With the plug member in place, a bonnet may be removably coupled to the valve body and at least partially within the central chamber in a step 560, wherein one or more substantially axial compression members are positioned between the bonnet and the inlet and outlet seal inserts prior to removably coupling the bonnet. In accordance with one embodiment of the disclosure, the one or more substantially axial compression members may be included within the bonnet using one or more compression member retaining devices prior to removably coupling the bonnet. The method could end in a stop step 570.

Referring to FIG. 6, depicted is a well system 600 including an exemplary operating environment that the apparatuses, systems and methods disclosed herein may be employed. Unless otherwise stated, the horizontal, vertical, or deviated nature of any figure is not to be construed as limiting the wellbore to any particular configuration. As depicted, the well system 600 may suitably comprise a drilling rig 610 positioned on the earth's surface 620 and extending over and around a wellbore 630 penetrating a subterranean formation 625 for the purpose of recovering hydrocarbons and the such. The wellbore 630 may be drilled into the subterranean formation 625 using any suitable drilling technique. In an embodiment, the drilling rig 610 comprises a derrick 612 with a rig floor 614. The drilling rig 610 may be conventional and may comprise a motor driven winch and/or other associated equipment for extending a work string, a casing string, or both into the wellbore 630. While a drilling rig 610 is shown in FIG. 6, other embodiments exist wherein the drilling rig 610 has been removed or is otherwise not present.

In the particular embodiment of FIG. 6, coupled proximate the derrick 612 is a plug valve 618. The plug valve 618, in accordance with the disclosure, is configured to control fluid flow, and thus fluid pressure, at one or more points in the well system 600. In the particular embodiment of FIG. 6, the plug valve 618 is controlling fluid flow between an uphole apparatus and the wellbore 630, for example using coiled tubing in one example. Nonetheless, the present disclosure should not be limited to any particular use for the plug valve 618. Additionally, while the plug valve 618 is being used in a fracturing process in the illustrated embodiment of FIG. 6, other uses for the plug valve 618 include a use during a cementing process, or any other high pressure process. The plug valve 618 illustrated in FIG. 6, may be similar to the plug valve 300 illustrated in FIGS. 3 and 4, or alternatively may be any other plug valve manufactured in accordance with the disclosure.

In an embodiment, the wellbore 630 may extend substantially vertically away from the earth's surface 620 over a vertical wellbore portion 632, or may deviate at any angle from the earth's surface 620 over a deviated or horizontal wellbore portion 634. In an embodiment, the wellbore 630 may comprise one or more deviated or horizontal wellbore portions 634. In alternative operating environments, portions or substantially all of the wellbore 630 may be vertical, deviated, horizontal, and/or curved. The wellbore 630, in this embodiment, includes a casing string 640. In the embodiment of FIG. 6, the casing string 640 is secured into position in the subterranean formation 625 in a conventional manner using cement 650.

In accordance with one embodiment of the disclosure, the well system 600 includes one or more fracturing zones. While only two fracturing zones (e.g., a lower fracturing zone 660 and upper fracturing zone 670) are illustrated in FIG. 6, it should be understood that the number of fracturing zones for a given well system 600 is almost limitless. In the embodiment of FIG. 6, the lower fracturing zone 660 has already been fractured, as illustrated by the fractures 665 therein. In contrast, the upper fracturing zone 670 has not been fractured, but in this embodiment is substantially ready for fracturing. Fracturing zones, such as those in FIG. 6, may vary is depth, length (e.g., 30-150 meters in certain situations), diameter, etc., and remain within the scope of the present disclosure.

The well system 600 of the embodiment of FIG. 6 further includes a service tool assembly 680 positioned in and around (e.g., in one embodiment at least partially between) the lower fracturing zone 660 and upper fracturing zone 670. In the embodiment of FIG. 6, the service tool assembly 680, with the assistance of other fracturing apparatuses (e.g., upper and lower zone packer assemblies), is configured to substantially if not completely isolate the upper fracturing zone 670 from the lower fracturing zone 660.

While the well system 600 depicted in FIG. 6 illustrates a stationary drilling rig 610, one of ordinary skill in the art will readily appreciate that mobile workover rigs, wellbore servicing units (e.g., coiled tubing units), and the like may be similarly employed. Further, while the well system 600 depicted in FIG. 6 refers to a wellbore penetrating the earth's surface on dry land, it should be understood that one or more of the apparatuses, systems and methods illustrated herein may alternatively be employed in other operational environments, such as within an offshore wellbore operational environment for example, a wellbore penetrating subterranean formation beneath a body of water.

Aspects disclosed herein include:

A. A plug valve including a valve body having an inlet port, an outlet port and a central chamber extending between the inlet port and the outlet port an inlet seal insert disposed within the central chamber and having an inlet bore extending there through and substantially aligned with the inlet port, an outlet seal insert disposed within the central chamber having an outlet bore extending there through and aligned with the outlet port, a plug member disposed in the central chamber, the plug member moveable between an open position facilitate fluid flow through the plug valve and a closed position to block fluid flow through the plug valve, a bonnet disposed at least partially within the central chamber and removably coupled to the valve body, and one or more substantial axial compression members positioned between the bonnet and the inlet and outlet seal inserts

B. A well system, the well system including a wellbore penetrating a subterranean formation, an oil/gas service tool assembly positioned within the wellbore, a plug valve in fluid communication with the oil/gas service tool assembly. The plug valve may include a valve body having an inlet port, an outlet port and a central chamber extending between the inlet port and the outlet port, an inlet seal insert disposed within the central chamber and having an inlet bore extending there through and substantially aligned with the inlet port, an outlet seal insert disposed within the central chamber having an outlet bore extending there through and aligned with the outlet port, a plug member disposed in the central chamber, the plug member moveable between an open position to facilitate fluid flow through the plug valve and a closed position to block fluid flow through the plug valve, a bonnet disposed at least partially within the central chamber and removably coupled to the valve body, and one or more substantially axial compression members positioned between the bonnet and the inlet and outlet seal inserts.

A method of assembling a plug valve, including providing a valve body having an inlet port, an outlet port and a central chamber extending between the inlet port and the outlet port, disposing an inlet seal insert within the central chamber and having an inlet bore extending there through and substantially aligned with the inlet port, disposing an outlet seal insert within the central chamber having an outlet bore extending there through and aligned with the outlet port, inserting a plug member in the central chamber, the plug member moveable between an open position to facilitate fluid flow through the plug valve and a closed position to block fluid flow through the plug valve, and removably coupling a bonnet to the valve body and at least partially within the central chamber, wherein one or more substantially axial compression members are positioned between the bonnet and the inlet and outlet seal inserts prior to removably coupling the bonnet.

Aspects A, B and C may have one or more of the following additional elements in combination:

Element 1: wherein the one or more substantially axial compression members are one or more substantially axial spring members. Element 2: wherein the one or more substantially axial spring members are one more substantially axial compression springs. Element 3: wherein the one or more substantially axial compression springs are coil springs, machined springs, wave spring, volute springs, or gas/hydraulic springs. Element 4: wherein the one or more substantially axial compression springs provide a substantially constant spring force in their deflection cycle. Element 5: wherein the one or more substantially axial compression members are one or more crush sleeves, belleville washers or bladder members. Element 6: wherein corresponding surfaces of the valve body and the bonnet cause the bonnet to limit out within the central chamber as the bonnet is removably coupled to the valve body. Element 7: wherein the valve body has a valve body no go shoulder and the bonnet has a corresponding bonnet no go shoulder, and further wherein the bonnet no go shoulder is configured to limit out against the valve body no go shoulder as the bonnet is removably coupled to the valve body. Element 8: further including one or more compression member retaining devices, the one or more compression member retaining devices configured to maintain the substantially axial compression members within the bonnet during assembly of the plug valve. Element 9: wherein the bonnet is threadedly coupled to the valve body. Element 10: wherein the valve body is a tapered valve body. Element 11: wherein the oil/gas service tool is an oil/gas fracturing tool. Element 12: wherein the oil/gas service tool is an oil/gas cementing tool. Element 13: further including retaining the substantially axial compression members within the bonnet using one or more compression member retaining devices prior to removably coupling the bonnet.

Those skilled in the art to which this application relates will appreciate that other and further additions, deletions, substitutions and modifications may be made to the described embodiments.

1. A plug valve, comprising:
a valve body having an inlet port, an outlet port and a central chamber extending between the inlet port and the outlet port;
an inlet seal insert disposed within the central chamber and having an inlet bore extending there through and substantially aligned with the inlet port;
an outlet seal insert disposed within the central chamber having an outlet bore extending there through and aligned with the outlet port;
a plug member disposed in the central chamber the plug member moveable between an open position to facilitate fluid flow through the plug valve and a closed position to block fluid flow through the plug valve;
a bonnet disposed at least partially within the central chamber and removably coupled to the valve body; and
one or more substantially axial compression members positioned between the bonnet and the inlet and outlet seal inserts.

2. The plug valve as recited in claim 1, wherein the one or more substantially axial compression members are one or more substantially axial spring members.

3. The plug valve as recited in claim 2, wherein the one or more substantially axial spring members are one or more substantially axial compression springs.

4. The plug valve as recited in claim 3, wherein the one or more substantially axial compression springs are coil springs, machined springs, wave spring, volute springs, or gas/hydraulic springs.

5. The plug valve as recited in claim 3, wherein the one or more substantially axial compression springs provide a substantially constant spring force in their deflection cycle.

6. The plug valve as recited in claim 1, wherein the one or more substantially axial compression members are one or more crush sleeves, belleville washers or bladder members.

7. The plug valve as recited in claim 1, wherein corresponding surfaces of the valve body and the bonnet cause the bonnet to limit out within the central chamber as the bonnet is removably coupled to the valve body.

8. The plug valve as recited in claim 7, wherein the valve body has a valve body no go shoulder and the bonnet has a corresponding bonnet no go shoulder, and further wherein the bonnet no go shoulder is configured to limit out against the valve body no go shoulder as the bonnet is removably coupled to the valve body.

9. The plug valve as recited in claim 1, further including one or more compression member retaining devices, the one or more compression member retaining devices configured to maintain the substantially axial compression members within the bonnet during assembly of the plug valve.

10. The plug valve as recited in claim 1, wherein the bonnet is threadedly coupled to the valve body.

11. The plug valve as recited in claim 1, wherein the valve body is a tapered valve body.

12. A well system, comprising:
a wellbore penetrating a subterranean formation;
an oil/gas service tool assembly positioned within the wellbore; and
a plug valve in fluid communication with the oil/gas service tool assembly, the plug valve including;
a valve body having an inlet port, an outlet port and a central chamber extending between the inlet port and the outlet port;
an inlet seal insert disposed within the central chamber and having an inlet bore extending there through and substantially aligned with the inlet port;
an outlet seal insert disposed within the central chamber having an outlet bore extending there through and aligned with the outlet port;
a plug member disposed in the central chamber, the plug member moveable between an open position to facilitate fluid flow through the plug valve and a closed position to block fluid flow through the plug valve;
a bonnet disposed at least partially within the central chamber and removably coupled to the valve body; and
one or more substantially axial compression members positioned between the bonnet and the inlet and outlet seal inserts.

13. The well system as recited in claim 12, wherein the oil/gas service tool is an oil/gas fracturing tool.

14. The well system as recited in claim 12, wherein the oil/gas service tool is an oil/gas cementing tool.

15. The well system as recited in claim 12, wherein the one or more substantially axial compression members are one or more substantially axial compression springs selected from the group consisting of coil springs, machined springs, volute springs, or gas springs.

16. The well system as recited in claim 12, wherein the one or more substantially axial compression members are one or more crush sleeves, belleville washers or bladder members.

17. The well system as recited in claim 12, wherein the valve body has a valve body no go shoulder and the bonnet has a corresponding bonnet no go shoulder, and further wherein the bonnet no go shoulder is configured to limit out against the valve body no go shoulder as the bonnet is removably coupled to the valve body.

18. The well system as recited in claim 12, further including one or more compression member retaining devices, the one or more compression member retaining devices configured to maintain the substantially axial compression members within the bonnet during assembly of the plug valve.

19. A method of assembling a plug valve, comprising:
providing a valve body having an inlet port, an outlet port and a central chamber extending between the inlet port and the outlet port;
disposing an inlet seal insert within the central chamber and having an inlet bore extending there through and substantially aligned with the inlet port;
disposing an outlet seal insert within the central chamber having an outlet bore extending there through and aligned with the outlet port;
inserting a plug member in the central chamber, the plug member moveable between an open position to facilitate fluid flow through the plug valve and a dosed position to block fluid flow through the plug valve;
removably coupling a bonnet to the valve body and at least partially within the central chamber, wherein one or more substantially axial compression members are positioned between the bonnet and the inlet and outlet seal inserts prior to removably coupling the bonnet.

20. The method of claim 19, further including retaining the substantially axial compression members within the bonnet using one or more compression member retaining devices prior to removably coupling the bonnet.
